(19) United States
(12) Patent Application Publication
(10) Pub. No.: US 2014/0189871 A1
(43) Pub. Date: Jul. 3, 2014

(54) Identifying Code Signatures Using Metamorphic Code Generation

(71) Applicant: Andre L. Nash, Portland, OR (US)

(72) Inventor: Andre L. Nash, Portland, OR (US)

(21) Appl. No.: 13/729,209

(22) Filed: Dec. 28, 2012

(51) Int. Cl. G06F 21/50; G06F 21/56

(52) U.S. Cl. CPC G06F 21/50; G06F 21/561
USPC 726/24; 726/22

(57) ABSTRACT

The identification of semantically equivalent code is aided by leveraging multiple authorities to produce equivalent groups of instructions given an input group of instructions. Thus, such authorities include hardware only authorities such as processors, software only authorities such as compilers and virtual non-virtual runtime environments that utilize both software and hardware.

### BACKGROUND

This relates generally to identifying signatures that indicate particular code segments.

The identification of unique software signatures for portions of applications at the instruction or assembly level may be important in identifying infringing structures or malware or in debugging. A signature is any indicia that identifies whether code is the same as other code.

Modern techniques for defeating such schemes include polymorphic and metamorphic code generation, where the evading application rewrites itself with the property that the resulting code does not look like its parent code but produces the exact same result.

### BRIEF DESCRIPTION OF THE DRAWINGS

Some embodiments are described with respect to the following figures:

FIG. 1 is a schematic depiction of one embodiment;

FIG. 2 is a flow chart for a sequence according to one embodiment; and

FIG. 3 is a system depiction for one embodiment.

### DETAILED DESCRIPTION

In accordance with some embodiments, the identification of metamorphically generated code may be aided by metamorphically generating code from different code sources.

Three authoritative sources, called authorities herein, of semantic-preserving metamorphic or polymorphic operations on a group of instructions include a compiler, a virtual machine and a target processor. In other cases more than one target processor may exist including a graphics processor, a dedicated processor such as a management engine, a security engine, or any of a variety of auxiliary processors. Processors perform instruction reordering or register reallocation on the fly given the processor's internal state. Compilers, with higher level information about the intent of the compiled software, are in an equally advantageous position to evaluate whether or not two pieces of code are semantically equivalent. In the middle of a continuum lie virtual runtime environments such as virtualization software or in the case of just-in-time compiled platforms, such as Java or .NET, that use information about the hardware as well as a high level information about the software, to produce optimal code.

Applications can also potentially span various platforms and/or operating systems. A bilingual processor is a processor that converts groups of instructions between architectures. A bilingual processor is in a highly unique position to serve as a translator and can create semantically equivalent code segments or malware between platforms. Similarly, software compilers such as GCC, have identical front-ends and result in platform specific code generated from back-ends that are operating system and platform aware. Such compilers are also in an advantageous position to serve as a translator between operating systems and platforms.

In accordance with some embodiments, the identification of semantically equivalent code is aided by leveraging multiple authorities to produce equivalent groups of instructions given an input group of instructions. As used herein, “semantically equivalent” means that the code may be different in expression but the result produced by the code is substantially the same. Thus, such authorities include hardware only authorities such as processors, software only authorities such as compilers and virtual non-virtual runtime environments that utilize both software and hardware. As used herein, an authority is software or hardware capable of generating metamorphic code. A processor can be more than one authority since it may be an authority in multiple platforms. A given processor (compiler or virtual machine, even), for example, may be an authority in ×86 and an authority in ×64 instruction sets, as well as a variety of extensions (SSEx, MMX, etc).

A code generation engine takes as an input a set of bytes that can be interpreted as instructions or in the case of a platform, like Java or .NET, a byte code. The output is a list of equivalent groups of instructions.

In the case of hardware based solutions, record statements can be introduced into the platform. For example to inspect a group of instructions, begin inspect and end-inspect statements may be introduced to record groups of instructions. When the end-inspect statement is reached, a metamorphic engine can produce groups of instructions that is semantically equivalent to the recorded state.

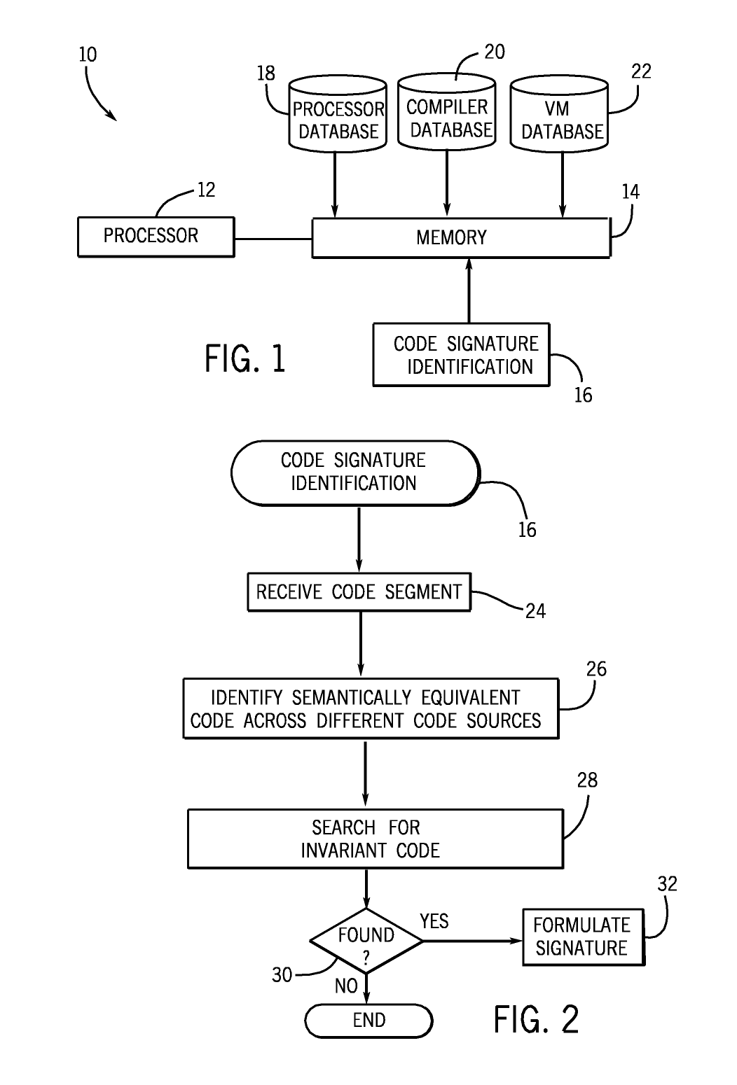

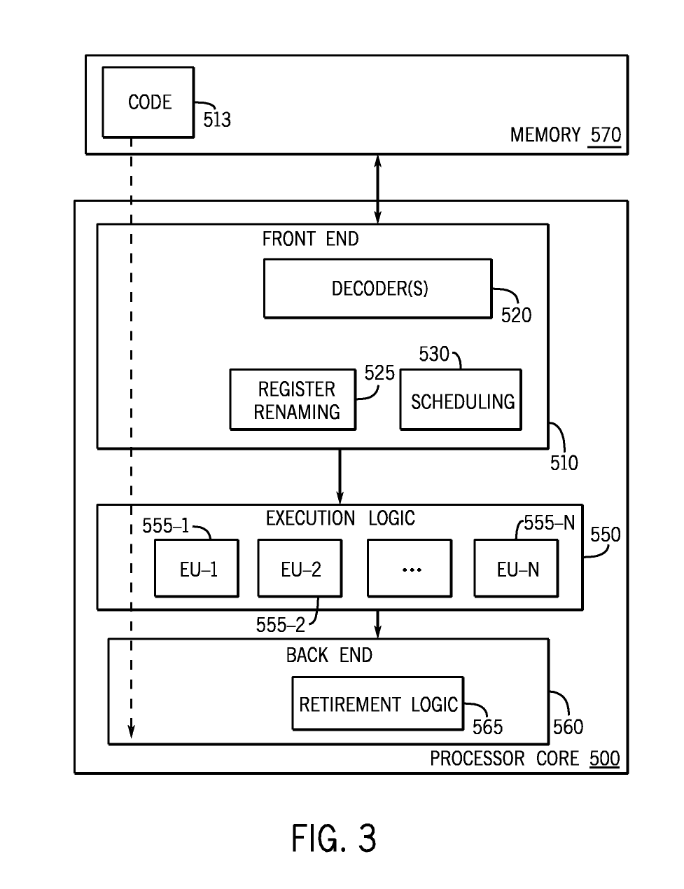

Referring to FIG. 1, a platform 10 may include a processor 12 coupled to a memory 14. The memory may store code signature identification module 16. It may be responsible for identifying the signatures of certain code segments be it malware or, potentially, intellectual property infringing code, as two examples. The memory 14, in one embodiment, can also support databases of processor versions 18, compiler versions 20 and virtual machine versions 22.

The code signature identification module 16, shown in FIG. 2, may be implemented in software, firmware and/or hardware. In software and firmware embodiments it may be implemented by computer executed instructions stored in one or more computer readable media, such as non-transitory computer readable storage media including magnetic, semiconductor or optical storage media.

Program code, or instructions, may be stored in, for example, volatile and/or non-volatile memory, such as storage devices and/or an associated computer readable or computer accessible medium including, but not limited to, solid-state memory, hard-drives, floppy disks, optical storage, tapes, flash memory, memory sticks, digital video disks, digital versatile discs (DVDs), etc., as well as more exotic mediums such as machine-accessible biological state preserving storage. A computer readable medium may include any mechanism for storing, transmitting, or receiving information in a form readable by a machine, and the medium may include a medium through which the program code may pass, such as antennas, optical fibers, communications interfaces, etc. Program code may be transmitted in the form of packets, serial data, parallel data, etc., and may be used in a compressed or encrypted format.

The module 16 may begin by receiving a code segment of interest as indicated in block 24. This code segment may be one that is suspected of being malware or one that is suspected of being patent or copyright infringing. It may also simply be code that is of interest for debugging.

Next, semantically equivalent code across different authorities is identified in block 26. This may be done using the different databases for different sources such as a processor database 18, a compiler database 20, and a virtual machine database 22.

Once semantically equivalent code across more than one authority has been identified, then that semantically equivalent code is searched for an invariant code portion as indicated in block 28. “Invariant code” means a portion of that segment of code is semantically equivalent and therefore serves as a flag or indicator for the presence of the larger semantically equivalent code segment. An example is a bilingual processor that “knows” two platforms. Invariant code cannot be checked by strict equality because the platforms are nowhere near equivalent (instructions do not all map equally across the platforms, but they may share an add or sub instruction), but the understanding of whether code is invariant has to be based on how the processor viewed what the instruction did to the processor. If codes are semantically equivalent, then their signatures should match. Once the invariant code has been found, the search for semantically equivalent code may be substantially simplified since it is no longer necessary to determine whether the code performs the same function but instead the invariant code portion only can be searched for in code from different sources.

If an invariant code portion is found, as determined in diamond 30, a signature may be formulated as indicated in block 32 to facilitate further automated searches. If no such invariant code is found, the flow may end.

One application is in connection with developing antivirus code. Once a virus is identified, the scheme may be utilized to find an invariant code that can be searched for in any subsequent cases. One advantageous result is that regardless of which of a variety of authorities is used to generate the metamorphic code, its signature may reveal the malware. For example, if processors, virtual machines and compilers are all analyzed, a more complete set of semantically equivalent code is developed and a more accurate determination of invariant code may result. This may result in better virus protection in some embodiments.

In accordance with another embodiment, crowd sourcing can be used to further enhance the identification of ever more efficient code signatures. For example, a software provider may provide the software that develops the code signature for many different users. Then, one platform for each copy of the software may automatically report back to the software provider whenever that software identifies a code signature on its platform. Over time, a large number of such crowd sourced code signatures, on a wide variety of different platforms with different processors, compilers and virtual machines, may be collected by the software provider to further refine the code signature for a particular type of metamorphic code. That is, even more accurate code signatures, good for a larger group of code sources, may be derived.

In still another example, instead of using different sources or in addition thereto, a given processor, or other code source, may be exercised using particularly defined code or any code. For example, code that is amenable to being compiled in different ways may be run on a given code source to see all the various code metamorphoses that result. Those various versions may then be compared to come up with source invariant signatures.

For example, in one embodiment, as a result of metamorphosis, different versions of the metamorphized code may be produced at different points during compilation. If these outputs were preserved, these versions can be used to see the different ways that the code could be changed. For example, each time the code is run a different way, but still arrives at the same state, the variant may be output. These variations are not otherwise recorded if they are intermediate results.

As another embodiment, particular code with particular code segments may be run and the code sources told that each time the code reaches a given state that the ways that the code reached that state should be saved and ultimately output for use in developing invariant code.

In still another other example, processors and virtual machines that are able to duplicate other environments can be run in those different environments to create more metamorphized versions of the code that then may be compared for developing invariant signatures. For example, a virtual machine that is capable of using a Windows® operating system and an Apple operating system can be used to develop more metamorphic variations.

Thus in some embodiments, the idea is to use code that creates variance or, a situation that creates variance in the way that the code is generated, in order to come up with a compilation of a substantial body of different code that could be created in the same circumstance. These types of metamorphized code can then be used to identify all the possible variants that then can be searched for invariant code to come up with signatures.

FIG. 5 illustrates a processor core 500 according to an embodiment. The core 500 may be part of the processor 12 of FIG. 1. Processor core 500 may be the core for any type of processor, such as a micro-processor, an embedded processor, a digital signal processor (DSP), a network processor, or other device to execute code. Although only one processor core 500 is illustrated in FIG. 5, a processing element may alternatively include more than one of the processor core 500 illustrated in FIG. 5. Processor core 500 may be a single-threaded core or, for at least one embodiment, the processor core 500 may be multithreaded in that it may include more than one hardware thread context (or “logical processor”) per core.

FIG. 5 also illustrates a memory 570 coupled to the processor 500. The memory 570 may be any of a wide variety of memories (including various layers of memory hierarchy) as are known or otherwise available to those of skill in the art. The memory 570 may include one or more code instruction(s) 513 to be executed by the processor 500. The processor core 500 follows a program sequence of instructions indicated by the code 513. Each instruction enters a front end portion 510 and is processed by one or more decoders 520. The decoder may generate as its output a micro operation such as a fixed width micro operation in a predefined format, or may generate other instructions, microinstructions, or control signals, which reflect the original code instruction. The front end 510 also includes register renaming logic 525 and scheduling logic 530, which generally allocate resources and queue the operation corresponding to the convert instruction for execution.

The processor 500 is shown including execution logic 550 having a set of execution units 555-1 through 555-N. Some embodiments may include a number of execution units dedicated to specific functions or sets of functions. Other embodiments may include only one execution unit or one execution unit that can perform a particular function. The execution logic 550 performs the operations specified by code instructions.

After completion of execution of the operations specified by the code instructions, back end logic 560 retires the instructions of the code 513. In an embodiment, the processor core 500 allows out of order execution but requires in order retirement of instructions. Retirement logic 565 may take a variety of forms as known to those of skill in the art (e.g., re-order buffers or the like). In this manner, the processor core 500 is transformed during execution of the code 513, at least in terms of the output generated by the decoder, the hardware registers and tables utilized by the register renaming logic 525, and any registers (not shown) modified by the execution logic 550.

Although not illustrated in FIG. 5, a processing element may include other elements on chip with the processor core 500. For example, a processing element may include memory control logic along with the processor core 500. The processing element may include I/O control logic and/or may include I/O control logic integrated with memory control logic. The processing element may also include one or more caches.

The following clauses and/or examples pertain to further embodiments:

One example embodiment may be at least one computer readable medium comprising one or more instructions that when executed by a processor: develop semantically equivalent code based on two authorities, identify a code segment that appears in code developed by both authorities, and use said code segment to identify semantically equivalent code. The medium wherein said authorities include at least two of a compiler, a virtual machine and a processor. The medium wherein said authorities include two platforms run by the same processor. The medium may further include instructions to identify intellectual property infringement. The medium may further include instructions to identify viruses using said code segment. The medium may further include instructions to identify different metamorphic code using a signature that is shorter than said code. The medium may further include instructions to identify said signature by developing metamorphic code from each of a processor, a compiler and a virtual machine.

Another example embodiment may be a method comprising developing semantically equivalent code on two authorities, identifying a code segment that appears in code developed by both authorities, and using said code segment to identify semantically equivalent code. The method may include at least two of a compiler, a virtual machine and a processor. The method may include identifying intellectual property infringement. The method may include identifying viruses using said code segment. The method may include identifying different metamorphic code using a signature that is shorter than said code. The method may include identifying said signature by developing metamorphic code from each of a processor, a compiler and a virtual machine. The method may include two platforms run by the same processor.

Another example embodiment may be an apparatus comprising a processor to develop semantically equivalent code on two authorities, identify a code segment that appears in code developed by both authorities, and use said code segment to identify semantically equivalent code, and a memory coupled to said processor. The apparatus may include said authorities include at least two of a compiler, a virtual machine and a processor. The apparatus may include said processor to identify intellectual property infringement. The apparatus may include said processor to identify viruses using said code segment. The apparatus may include said processor to identify different metamorphic code using a signature that is shorter than said code. The apparatus may include said processor to identify said signature by developing metamorphic code from each of a processor, a compiler and a virtual machine.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. At least one non-transitory computer readable storage medium comprising one or more instructions that when executed by a processor:
develop semantically equivalent code based on two authorities;
identify a code segment that appears in code developed by both authorities; and
use said code segment to identify semantically equivalent code.

2. The medium of claim 1 wherein said authorities include at least two of a compiler, a virtual machine and a processor.

3. The medium of claim 1 wherein said authorities include two platforms run by the same processor.

4. The medium of claim 1 further including instructions to identify intellectual property infringement.

5. The medium of claim 1 further including instructions to identify viruses using said code segment.

6. The medium of claim 1 further including instructions to identify different metamorphic code using a signature that is shorter than said code.

7. The medium of claim 6 further including instructions to identify said signature by developing metamorphic code from each of a processor, a compiler and a virtual machine.

8. A computer executed method comprising:
using a computer to develop semantically equivalent code on two authorities;
identifying a code segment that appears in code developed by both authorities; and
using said code segment to identify semantically equivalent code.

9. The method of claim 8 wherein said authorities include at least two of a compiler, a virtual machine and a processor.

10. The method of claim 8 including identifying intellectual property infringement.

11. The method of claim 8 including identifying viruses using said code segment.

12. The method of claim 8 including identifying different metamorphic code using a signature that is shorter than said code.

13. The method of claim 12 including identifying said signature by developing metamorphic code from each of a processor, a compiler and a virtual machine.

14. The method of claim 8 wherein said authorities include two platforms run by the same processor.

15. An apparatus comprising:
a processor to develop semantically equivalent code on two authorities, identify a code segment that appears in code developed by both authorities, and use said code segment to identify semantically equivalent code; and
a memory coupled to said processor.

16. The apparatus of claim 15 wherein said authorities include at least two of a compiler, a virtual machine and a processor.

17. The apparatus of claim 15, said processor to identify intellectual property infringement.

18. The apparatus of claim 15, said processor to identify viruses using said code segment.

19. The apparatus of claim 15, said processor to identify different metamorphic code using a signature that is shorter than said code.

20. The apparatus of claim 19, said processor to identify said signature by developing metamorphic code from each of a processor, a compiler and a virtual machine.
